(19) United States
(12) Patent Application Publication
(10) Pub. No.: US 2016/0173600 A1
(43) Pub. Date: Jun. 16, 2016

(54) PROGRAMMABLE PROCESSING ENGINE FOR A VIRTUAL INTERFACE CONTROLLER

(71) Applicant: CISCO TECHNOLOGY, INC., SAN JOSE, CA (US)

(72) Inventors: Michael B. Galles, Los Altos, CA (US); David A. Clear, San Jose, CA (US)

(73) Assignee: CISCO TECHNOLOGY, INC., SAN JOSE, CA (US)

(21) Appl. No.: 14/570,677

(22) Filed: Dec. 15, 2014

(51) Int. Cl. H04L 29/08; H04L 12/931; H04L 29/12

(52) U.S. Cl. CPC H04L 67/1097; H04L 61/1552; H04L 49/35

(57) ABSTRACT

A method is provided in one example embodiment and includes receiving at an interface controller associated with a host server and disposed between the host server and a network element a packet from a sender; processing the packet to identify a rewrite rule to be applied to the packet based on characteristics of the packet; applying the identified rewrite rule to the packet to generate a rewritten packet; and forwarding the rewritten packet toward a next hop. The processing may include classifying the packet, the classifying including identifying at least one of a type of traffic with which the packet is associated and an application with which the packet is associated. Additionally and/or alternatively, the processing may include performing a flow table lookup for the packet to identify a flow with which the packet is associated.

### TECHNICAL FIELD

This disclosure relates in general to the field of communications networks and, more particularly, to a programmable processing engine for implementation in a virtual interface controller in such networks.

### BACKGROUND

Data center networks and servers are evolving at a rapid pace, with new network overlay technologies, remote direct memory access protocols, and server management and control protocols continually being developed. Server interface solutions should be sufficiently flexible to adapt to future network protocols, as well as sufficiently capable of manipulating virtual interfaces and server memory. Disparate network packet processing and virtual interface memory and control access may not provide support for some of the system-wide evolving technologies and may provide insufficient support for multi-staged protocol and memory control technologies.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram illustrating a communication system in which a virtual interface controller (“VIC”) having a packet processing engine (“PPE”) may be implemented in accordance with embodiments described herein;

FIG. 2 is a simplified block diagram illustrating example details the VIC of FIG. 1 in accordance with embodiments described herein;

FIG. 3 is a simplified block diagram illustrating example details of the PPE of FIG. 2 in accordance with embodiments described herein;

FIG. 4 illustrates a format of a rewrite rule used to implement the PPE of FIG. 2 in accordance with embodiments described herein;

FIG. 5 is a simplified block diagram illustrating registers used to implement the PPE of FIG. 2 in accordance with embodiments described herein;

FIG. 6 is a simplified block diagram illustrating a layout of program memory of the PPE of FIG. 2 in accordance with embodiments described herein;

FIG. 7 is a flow diagram illustrating example operations that may be implemented by and associated with the PPE of FIG. 2 in accordance with embodiments described herein;

FIG. 8 illustrates a simplified example of a packet rewrite comprising GRE encapsulation of an original packet by the PPE of FIG. 2 in accordance with embodiments described herein; and

FIG. 9 illustrates a simplified block diagram illustrating components of an example machine capable of executing instructions in a processor, for implementation in a communication in accordance with embodiments described herein.

### DETAILED DESCRIPTION OF EXAMPLE EMBODIMENTS

### Overview

A method is provided in one example embodiment and includes receiving at an interface controller associated with a host server and disposed between the host server and a network element a packet from a sender; processing the packet to identify a rewrite rule to be applied to the packet based on characteristics of the packet; applying the identified rewrite rule to the packet to generate a rewritten packet; and forwarding the rewritten packet toward a next hop. The processing may include classifying the packet, the classifying including identifying at least one of a type of traffic with which the packet is associated and an application with which the packet is associated. Additionally and/or alternatively, the processing may include performing a flow table lookup for the packet to identify a flow with which the packet is associated. Applying the rewrite rule may include one or more of deleting byes of the packet, inserting bytes into packet, skipping byes of the packet, manipulating program registers using basic Arithmetic Logic Unit (“ALU”) operations, and performing a direct memory access of at least one of a memory device of the host server and a memory device of interface controller. In certain embodiments, the network element is a switch. The packet may be received from a virtual machine (“VM”) hosted by the host server. The packet may alternatively be received from the network element.

### Example Embodiments

Embodiments descried herein include a programmable packet processing engine (“PPE”) that may be embodied in a virtual interface controller (“VIC”), thereby placing a programmable processor in a unique location within a data center architecture. By virtue of its location in the VIC, the PPE can observe and control packets traveling to and from the data center network. The PPE can further observe memory transactions, controller register changes, and system interrupts directed to and from the server itself. Straddling the networking realm and the device driver interface realm, the PPE can realize new efficiencies and functionality that are not available with a purely network-based packet processor or a purely server-based device or interface controller. In certain embodiments, the mechanisms and instruction set architecture of the PPE are customized to handle packet header processing and direct memory access (“DMA”) operations with high efficiency. Each packet that arrives at the VIC can result in the launch of a targeted processing program based on the results of a programmable packet classifier or the results of a fine-grained flow table match, allowing custom program execution on a per-flow basis.

Examples of programs written for the PPE include packet encapsulation in a variety of tunnel protocols, stateless offload of VXLAN and NVGRE overlay network packets, RDMA over Converted Ethernet (“ROCE”) implemented for a virtual device, target management traffic separation, encapsulation and forwarding to management endpoints. The unique mechanism's combination of identifying packet types with a programmable classifier, identifying flows with a programmable flow table, and executing programs to manipulate headers as well as control settings and DMA operations enable the PPE to provide a unique set of features and services.

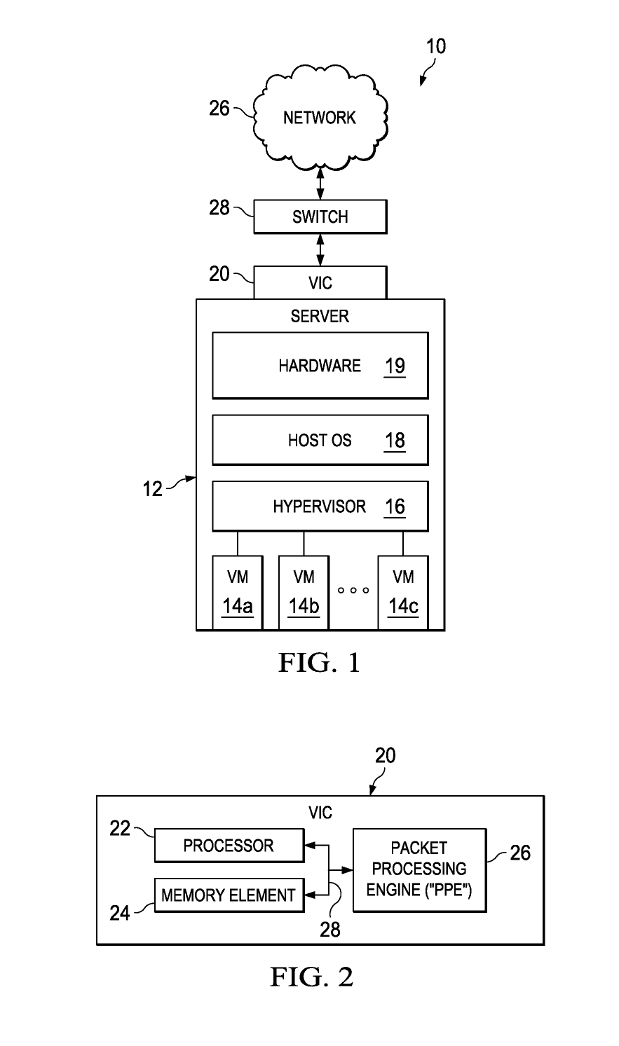

Turning to FIG. 1, FIG. 1 is a simplified block diagram illustrating a communication system 10 in which a VIC having a PPE may be implemented in accordance with one example embodiment. As shown in FIG. 1, the system 10 includes a server 12 on which are executing a plurality of virtual machines (“VMs”), represented in FIG. 1 by VMs 14a-14c, supported by a hypervisor 16. Server 12 further includes an operating system (“OS”) 18 and host hardware 19, which may include a processor, memory, and one or more I/O devices (not shown). Server 12 may be a stand-alone server or may be a part of a complex of servers in a data center infrastructure, for example. A virtual interface card (“VIC”) 20 is communicatively connected to server 12 and supports a variety of services with respect to the VMs 14a-14c, as will be described in greater detail below. As shown in FIG. 1, VIC 20 is connected to a computer network 26 via a network element, represented in FIG. 1 by a switch 28.

FIG. 2 is a more detailed block diagram of VIC 20 in accordance with embodiments described herein. As shown in FIG. 2, VIC 20 includes a processor 22 and a memory element 24 for purposes that will also be described in greater detail herein below. The functionality of VIC 20 may be implemented as one or more hardware components, one or more software components, or combinations thereof. In particular, processor 22 may be a programmable processor, microprocessor, or micro controller, or a fixed-logic processor. In the case of a programmable processor, memory element 24 may be any type of tangible processor-readable memory (e.g., Random Access Memory (“RAM”), Read Only Memory (“ROM”), etc.) that is encoded with or stores instructions for affecting the functionality of VIC 20 as described herein. In the case of a fixed-logic processing device, the logic or instructions may be encoded in an Application-Specific Integrated Circuit (“ASIC”), for example, or Digital Signal Processor (“DSP”) that is configured with firmware comprising instructions or logic for causing the processor 22 to perform the functions described herein. Thus, VIC 20 may take any of a variety of forms, so as to be encoded in one or more tangible media for execution, such as with fixed logic or programmable logic (e.g., software/computer instructions executed by a processor) and any processor may be a programmable processor, programmable digital logic (e.g., field programmable gate array) or an ASIC that comprises fixed digital logic, or a combination thereof. In general, any process logic may be embodied in a processor (or computer) readable medium that is encoded with instructions for execution by a processor that, when executed by the processor, are operable to cause the processor to perform the functions described herein. It should be noted that, although not illustrated in FIG. 2, in certain embodiments, a single VIC may be attached to a plurality of host servers.

Referring again to FIG. 2, VIC 20 also includes a packet processing engine (“PPE”) 26, which is communicatively coupled to processor 22 and memory element 24 via one or more communications channels, represented in FIG. 2 by communications channel 28. As will be described in detail below, processor 22, memory element 24, and PPE 26 all function together to provide packet processing services for packets being transmitted to and from the VMs 14a-14c as described hereinbelow.

PPE 26 is designed to support basic tunnel encapsulation and decapsulation, Ethertype insertion and removal, time stamping, and some NAT-like operations, as well as any number of other operations. As will be described in greater detail below, a core mechanism of the PPE is an instruction sequencer that executes a rewrite program to insert, delete, and manipulate targeted bytes in a packet. In one embodiment, rewrite programs, or rewrite rules, are 32, 64, or 128 bytes in length. The rewrite program applied to a particular packet is selected by a classifier and/or flow table search result 24-bit rewrite rule index. In certain embodiments, if a rewrite rule index is 0, no rewrite is performed; if a rewrite rule index is non-zero, one of up to 15 million rewrite rules is read from memory and applied to the packet. As will be described in greater detail below, this mechanism allows very specific rewrite rules to be applied to individual flows and allows more generic rules to be applied to Ternary Content Addressable Memory (“TCAM”) classification results.

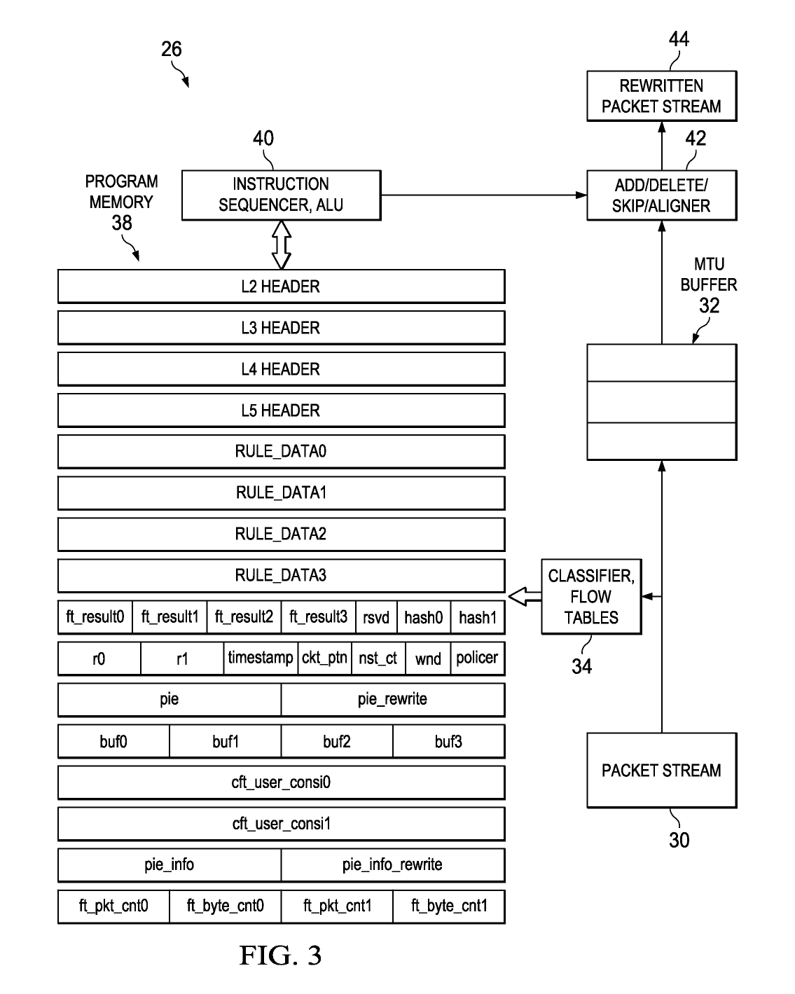

FIG. 3 is a flow diagram of PPE 26 in accordance with embodiments described herein. As shown in FIG. 3, PPE 26 receives a packet at point 30. In one embodiment, the packet originates from one of the VMs 14a-14c hosted on server 12. In other embodiment, the packet is received from router 28 and is destined for one of VMs 14a-14c. The received packet is stored in a Maximum Transmission Unit (“MTU”) buffer 32. Additionally, the received packet is classified by a packet classifier and/or a flow table lookup is performed in association with the packet, as represented by element 34. In particular, packet classifier classifies the packet and identifies a rewrite rule to be applied to the packet based on the classification thereof. Packets can be classified in any number of manners, including type of traffic (e.g., voice, data, video), an application with which the packet is associated (e.g., WebEx, File Transfer Protocol (“FTP”)), etc. Flow table lookup enables the packet to be identified as comprising a portion of a particular flow and is therefore more specific than classification.

The packet, as well as results of classification/flow table lookup, are stored in program memory 38. Program memory 38 is accessed by an instruction sequencer, which may be implemented using an arithmetic and logic unit (“ALU”), 40 for applying a rule associated with the packet classification/flow to the packet. In accordance with features of embodiments described herein, rules are stored in VIC memory and may be numbered (e.g., 1 to 16 million, in one application). The classifier and flow table results specify by number the rule to execute. Each instruction comprising the identified rule is applied to the packet at an add/delete/skip aligner module 42 under control of the sequencer 40 and the rewritten packet stream is output from the aligner module 42 at a point 44. Additionally, in accordance with features of embodiments descried herein, the sequencer 40 is able to perform direct memory access (“DMA”) operations in connection with host memory without knowledge, supervision, or involvement of the host OS. As a result, sequencer 40 can write data directly to and/or read data directly from host memory, as well as generate host interrupt events or store packet or flow state to VIC memory, as necessary to implement the identified rewrite rule. Sequencer 40 may also generate host interrupt events or store packet or flow state to VIC memory.

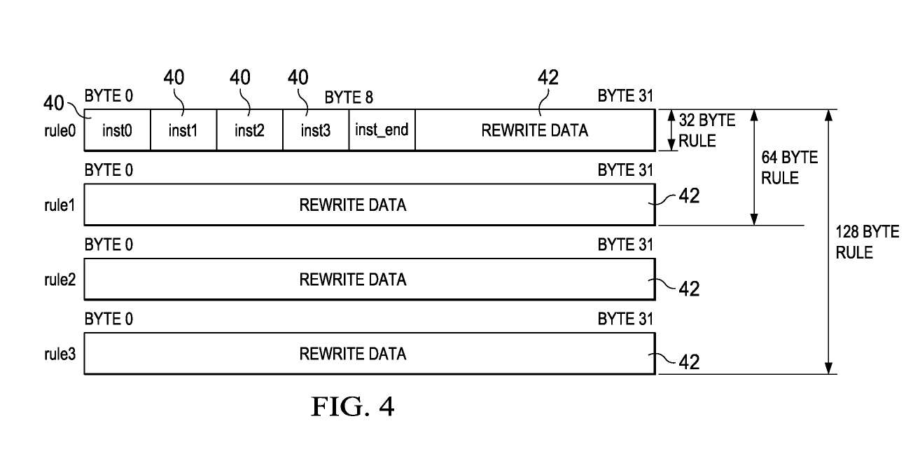

FIG. 4 illustrates a rewrite rule format in accordance with one embodiment. In one embodiment, each rewrite rule includes a series of 2-byte instructions 40 and program (“rewrite”) data 42. Instructions can delete bytes, insert bytes, skip bytes, manipulate program registers using basic Arithmetic Logic Unit (“ALU”) operations, perform DMA operations to/from host memory or VIC memory, or branch the instruction flow. The limit on the number of commands in a rewrite program may be the overall size of the program itself, which may be 32, 64, or 128 bytes; however, this limit can be extended using rewrite branch instructions and program load DMA operations. The rewrite command sequence is processed strictly in order and packet add, delete, and skip commands are applied to the packet strictly in order.

In certain embodiments, rewrite rules and data may be placed in memory in big endian format. In such embodiments, the instruction at byte 0 is always executed first and program execution continues until an END instruction is reached or an error occurs. Each rewrite instruction is applied at the current packet pointer. This pointer indicates where add/delete/skip instructions are applied to the packet. The packet pointer advances from offset 0 to the end of the packet location during processing and not in the reverse direction.

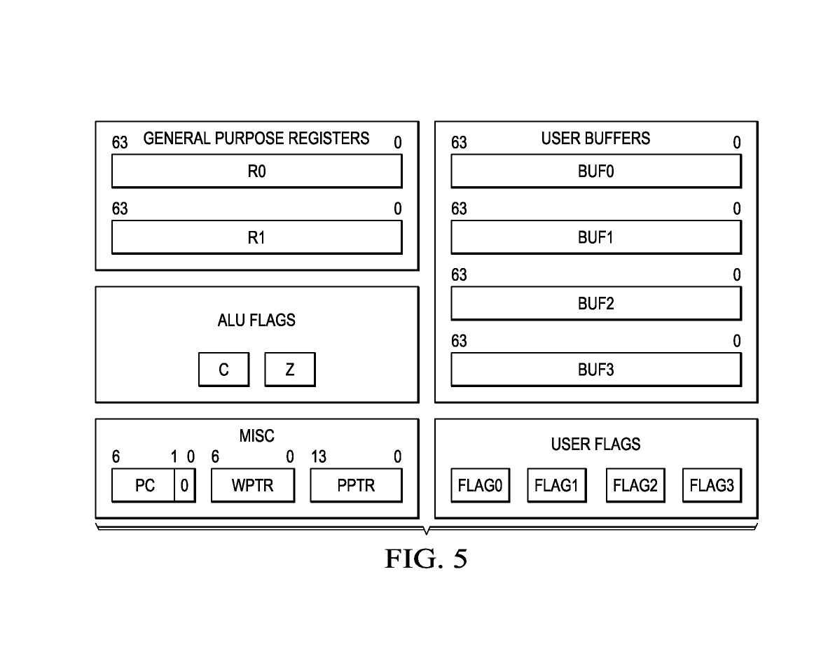

FIG. 5 is a depiction of a packet processing, or “rewrite,” engine register set in accordance with certain embodiments. As shown in FIG. 5, registers R0 and R1 are general purpose 64-bit registers used as source and/or destination in most instructions. When a new program is loaded, registers R0 and R1 will contain the last two dwords of the loaded program. For example, 32-byte rules will load register R0 with bytes 16-23 and will load register R1 with bytes 24-31. 64-byte rules will load register R0 with bytes 48-55 and will load register R1 with bytes 56-63. The C (“carry”) flag is updated by certain ALU operations, such as arithmetic operations. It reflects either the result of a borrow out of a subtract/compare operation or the last bit shifted out of a general purpose register (“GPR”) during a right shift. Its absolute status can be branched on using the BGE (C==0) instruction, but it is also used in other relational branches. The Z (“zero”) flag is updated by certain ALU operations. It is set to 1 when an ALU result is 0 or cleared if non-zero. Its absolute status can be branched on using BEQ (Z=1) or BNE (Z=0). The program counter PC is a 6-bit halfword index into memory at address 0x80, but from the ISA perspective, is viewed as a 7-bit byte index with bit zero forced to zero. This perspective is reflected in the Branch Register (“BR”) instruction, which copies bits 6 . . . 1 of a GPR into bits 6 . . . 1 of the PC. The WPTR is a 7-bit window pointer that is an offset into layer memory. Whenever a memory operation targets layer memory, the target address is offset by the value in the WPTR. It provides a register-indirect addressing mode that can point to the offset of an interesting item of data. In other words, it provides a sliding window view into the packet data.

The PPTR is a 14-bit packet pointer that is a byte index into the input packet. The INS/END instructions read bytes from this offset and copy them to the output packet. The DEL instructions advance the pointer forward without copying bytes, effectively removing them from the output stream. BUF0-BUF3 are 64-bit buffer registers usable as temporaries. FLAG0-FLAG3 are 1-bit discrete flags that may be set/cleared and branched upon. These may be used to remember conditions that are later branched upon.

The sequencer 40 performs operations on a GPR and an operand, which comes from memory or is an immediate value. Two ALU flags are maintained, including the C flag and the Z flag. The C flag is the carry-out from the operation. The Z flag is set if the 64-bit result of an operation is zero and cleared otherwise.

The ADD operation adds a literal or value form memory to a GPR. The operand is first zero-extended to 64-bits and then added to the BPR. The carry-in to the addition is zero. The C flag is set as the carry-out from bit 63. For example:

$$\begin{matrix}GPR \text{:} & 0 \_FFFFFFFF \_FFFFFFFF \\ Operand \text{:} & \underline{0 \; 00000000 \; 00000001 +} \\ & 1 \_ 00000000 \_ 00000000\end{matrix}$$

The result shows a C flag value of 1

Both the SUB (subtract) and CMP (compare) operations subtract a literal or memory-based operand from a GPR. The operand is first zero-extended to 64-bits and the carry-in is set to 1. The carry-out reflects the borrow from bit 64 to bit 63. The first example below shows a “no-borrow” case, in which the C flag remains set through the subtract. The second example shows a “borrow” case, in which the C flag is cleared.

$$\begin{matrix}GPR \text{:} & 0 \_ 00000000 \_ 00000001 \\ Operand \text{:} & \underline{0 \; 00000000 \; 00000001 -} \\ & 0 \_ 00000000 \_ 00000000\end{matrix}$$

$$\begin{matrix}GPR \text{:} & 0 \_ 00000000 \_ 00000001 \\ Operand \text{:} & \underline{0 \; 00000000 \; 00000002 -} \\ & 1 \_FFFFFFFF \_FFFFFFFF\end{matrix}$$

If the C flag is clear following a subtract of compare operation, then the GPR was greater than or equal to the operand. If the C flag is set, then the GPR was less than the operand. The branch instructions (e.g., BGT, BLT, etc.) are named from the GPR perspective (i.e., Branch if GPR was Greater Than the operand; Branch if GPR was Less Than the operand) and use the state of the C and Z flags to make the decision. The Left shift (“SLL”) and Rotate right (“ROTR”) instructions do not affect the C flag. Right shift instructions (“SRL,” “SRLV,” “SRLVM”) for each shift the bit from position 0 of the GPR shifts out into the C flag. The final value of the C flag will reflect the last bit shifted out of the GPR.

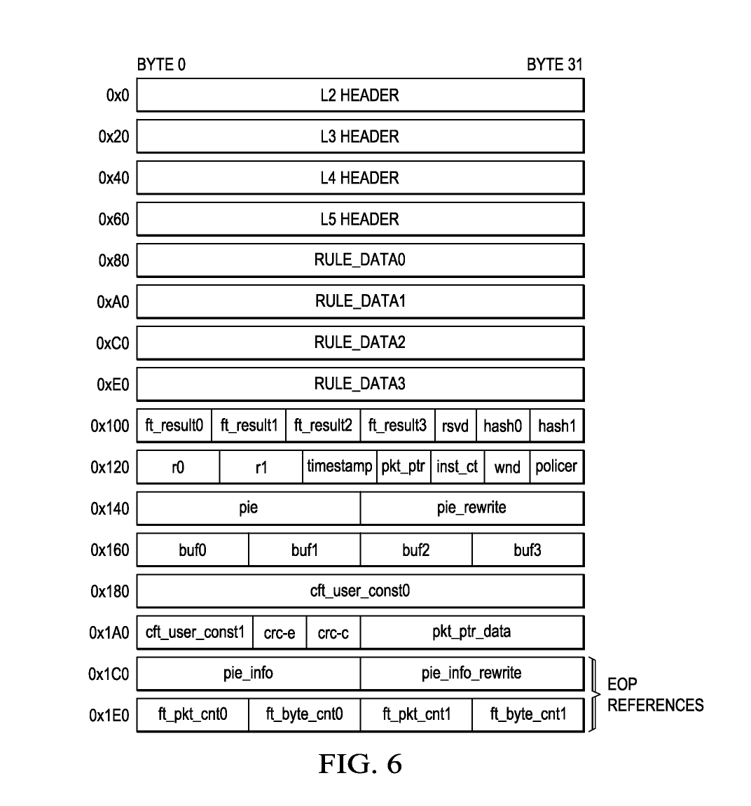

FIG. 6 is a more detailed depiction of the rewrite engine program memory 38. In certain embodiments, the memory available to a rewrite program is a 512-byte array, in big endian (network byte) order, that is initialized prior to rewrite program execution. The memory stores a combination of packet data, program memory, PIE header and PIE_Info, rewrite engine registers, and data from the flow tables. Referring to FIG. 6, memory address 0 (“L2 Header”) contains the first 32 bytes of data from an incoming packet. For ingress packets, this is after QTag modifications performed by the network block. For egress, this is the first 32 bytes of data as-is from the host driver (or loopback RQ) before network block QTag rewrite. Memory address 0x20 (“L3 Header”) contains the first 32 bytes of the layer 3 header. For egress, this memory space contains bytes [63:32] of the packet. In alternative implementations, both ingress and egress point to L3/L4/L5 as expected. Memory address 0x40 (“L4 Header”) contains the first 32 bytes of the layer 4 header. If the parser could not locate layer 4, this memory space contains bytes L3+32 to L3+64. For egress, this memory space always contains bytes [91:64] of the packet. Memory address 0x60 (“L5 header”) contains the first 32 bytes of the layer 5 header. If the parser could not find layer 5, this memory space contains bytes L4+32 to L3+64. For egress, this address space always contains bytes [127:92] of the packet. Memory address 0x80 (“rewrite buffer0”) contains the first 32 bytes of the rewrite rule and is also the target memory for RDEXT row 0 instructions, which are the basis for DMA operations. Memory address 0xA0 (“rewrite buffer1”) contains the second 32 bytes of the rewrite rule and is set to 0 for 32 byte rules. This memory space is also the target memory for RDEXT row 1 instructions. Memory address 0xC0 (“rewrite buffer2”) contains the third 32 bytes of the rewrite rule and is set to 0 for 32 byte rules. This memory space is also the target memory for RDEXT row 2 instructions. Memory address 0xE0 (“rewrite buffer4”) contains the fourth 32 bytes of the rewrite rule and is set to 0 for 32 byte rules and 64 byte rules. This memory space is also the target memory for RDEXT row 3 instructions.

Memory address 0x100 (“flow table and parser results”) contains flow table 0 result, index (byte [3:0]), flow table 1 result, index (byte [7:4]), flow table 2 result, index (byte [11:8]), flow table 3 result, index (byte [15:12]), flow table 0, 32-bit hash (byte [27:24]), and flow table 1, 32-bit hash (byte [31:28]). Memory address 0x120 (“rewrite engine registers”) contains GPR R0 and GPR R1, both of which are 64-bit general purpose registers. Note that R0 and R1 are loaded with the last two dwords of the rewrite rule when a new program is loaded. This memory space also contains a 64-bit value of cft_rewrite_timestamp (“timestamp”), which is a different timer from the 32-bit flow table netflow timestamp. Additionally, this is a free-running timer and may change during rewrite program execution, thereby allowing it to be used to measure packet latency through the rewrite engine. This memory space also contains a packet pointer (“pkt_ptr”) comprising a 16-bit pointer to the current position in the packet byte stream, an instruction counter (“inst_ct”) comprising an 8-bit count of the number of instructions executed for the program, a window pointer (“wnd”), which is used when loading bytes from the packet header memory region, and two policer marks (“policer”). Policer 1 mark is set if the policer marked the packet as exceeding the programmed rate for policer 1 and a policer 2 mark is set if the policer marked the packet as exceeding the programmed rate for policer 2.

Memory address 0x140 contains a pie header comprising the 128-bit original packet PIE header and the 128-bit rewritten packet PIE header. Memory address 0x160 contains user buffers including four buffers (buf0-buf3), writable by the rewrite program. The buffers are not reset after each packet; rather, their state is persistent across packets. The buffers also have write access from the control processor, which may be implemented as an eCPU. Memory address 0x180 contains 32 bytes of user-programmable constants, globally visible to the rewrite engine across all flows, LIFs. Memory address 0x1A0 contains 8 bytes of user-programmable constants, globally visible to the rewrite engine across all flows, LIFs. Memory address 0x1A8 contains a 4-byte Cyclic Redundancy Check 32 (“CRC-32”) (Ethernet/ROCE) result, 1s complemented and ready to be inserted. Memory address 0x1AC contains a 4-byte Cyclic Redundancy Check 32C (“CRC-32”) (iSCSI) result, 1s complemented and ready to be inserted. Memory address 0x1B0 contains packet pointer data (“pkt_ptr_data”) comprising the next 16 bytes of packet data that follow the current packet pointer. Memory address 0x1C0 contains PIE info (“pie_info”), including a 128-bit original packet PIE info header and a 128-bit rewritten packet PIE info header. It should be noted if the pie_info addresses are referenced by a rewrite program memory reference, the program will stall until the entire packet has been received. Memory address 0x1E0 contains netflow results comprising a 64-bit packet count from flow table 0, a 64-bit byte count from flow table 0, a 64-bit packet count from flow table 1, and a 64-bit byte count from flow table 1. It should be noted if the netflow results addresses are referenced by a rewrite program memory reference, the program will stall until the entire packet has been received.

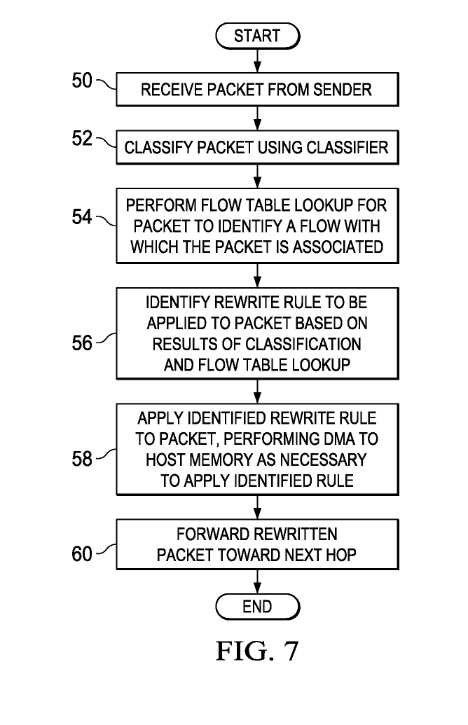

FIG. 7 is a flowchart illustrating operation of a PPE, such as PPE 26, in accordance with embodiments descried herein. In step 50, a packet is received from a sender. In certain embodiments, the sender is a VM; in other embodiments, the sender is a router or other network element. It will be recognized that the VIC may have two pipelines for implementing the PPE described herein, one of which handles traffic from VMs to the network and the other of which handles traffic directed from the traffic to VMs. In step 52, the packet is classified by the classifier. As previously noted, packets may be classified in any number of manners, including type of traffic (e.g., voice, data, video), an application with which the packet is associated (e.g., WebEx, YouTube), etc. In step 54, a flow table lookup is performed to identify a flow with which the packet is associated. In certain embodiments, the classifier step and/or the flow table step may be optional. For example, in certain embodiments, there may or may not be a classifier step. In embodiments in which there is a classifier step, there may or may not be a flow table step. In any case, classifying a packet and/or performing flow table lookup in connection with a packet may be generally referred to herein as “processing” the packet. In step 56, a rewrite rule to be applied to the packet is identified based on the results of classification and/or flow table lookup (i.e., the processing). In step 58, the identified rewrite rule is applied to the packet, with DMA to host memory performed as necessary as required by the identified rule. In step 60, the rewritten packet is forwarded toward the next hop.

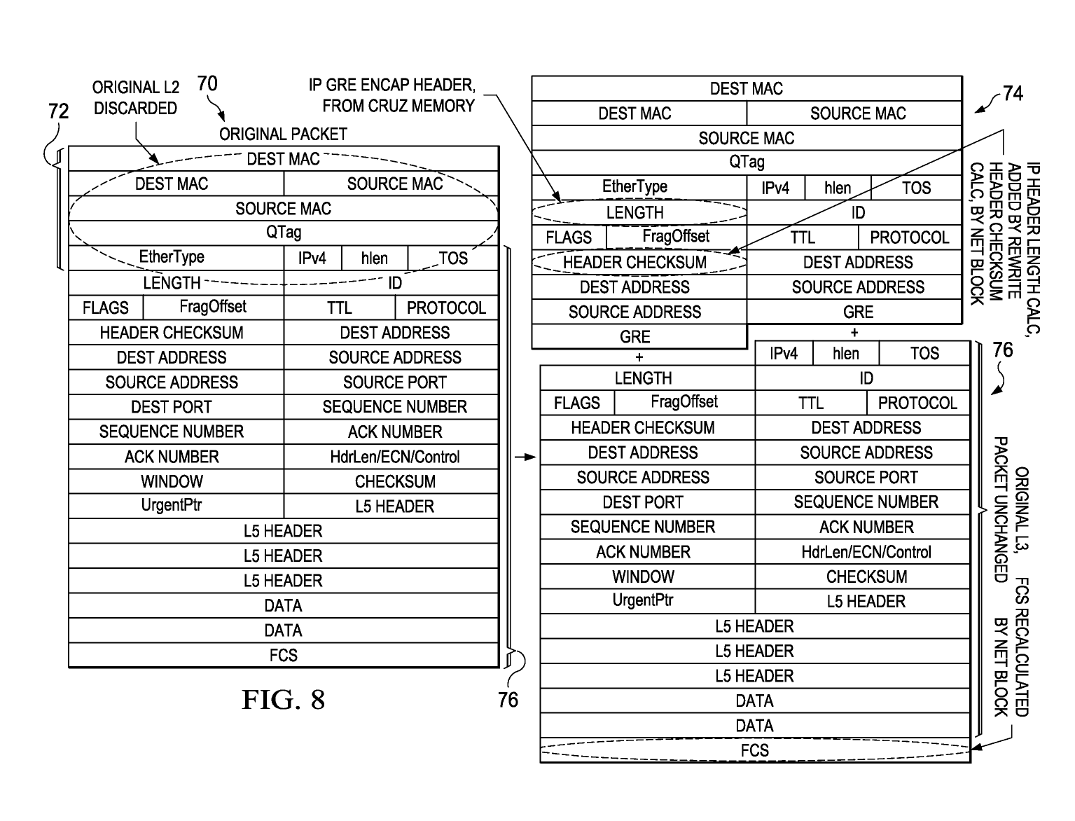

FIG. 8 illustrates an example of a packet rewrite in accordance with embodiments described herein for performing GRE encapsulation of an original packet 70 comprising an L2 portion 72 and an L3-L5 portion 74. The identified rewrite rule for the packet 70 results in the original L2 information 72 being discarded and replaced with an IP GRE encapsulation 76, which includes updated and additional data, such as IP header length and header checksum, among other fields. The IP GRE encapsulation 76 is added to the L3-L5 portion 74 of the original packet (with a recalculated frame check sequence (“FCS”) to constitute a rewritten packet to be forwarded on.

Embodiments described herein combine packet classification functionality, flow tables, and a programmable packet processing engine with direct access to memory, register, and interrupt resources in a VIC as well as a host server. This combination of mechanisms, which have been optimized to handle packet header manipulations as well as server memory DMA operations, allows features to be applied at the data center network edge that would not otherwise be possible. The embodiments enable implementation of new protocols with DMA interface semantics and enable network overlay protocols to be offloaded to the VIC, which has information on the server configuration as well as the network forwarding state. Protocols that require header manipulation stages based on network state as well as DMA operations based on server state can be combined in one location, offering higher efficiency and lower packet processing times. The programmable nature of the PPE allows it to implement future protocols that have not been invented, coupled with future server driver code which has not yet been written. Applying programmable packet processing operations at the edge of the compute network is more scalable than applying it at a central switch, allowing more involved and variable latency processing programs.

Embodiments described and illustrated herein combine a fully programmable packet classification, flow table, and rewrite engine with host DMA, interrupt, and message control. A fully programmable sequencer enables embodiments to observe and control data structures and packet contents in both the network in the host memory domains simultaneously while operating within the virtual device context protection and management domain required by well-known device driver models running on traditional operating system models. As a result, a variety of protocols and functions may be supported, including VXLAN and NVGRE protocol offloads running on a basic eNIC as well as RDMA over Ethernet devices, which require both memory-based scatter gather list traversal in the host memory domain and packet header manipulations, CRC calculations, and packet classifications in the network domain. Embodiments further enable integration of multiple programmable networking and computer system mechanisms at the key control point of the network/computer system boundary. As a result, the PPE has full control of network packet creation, DMA engine behavior, host driver interface communication, and virtual device management, which is a very powerful feature creation device.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

Note also that an “application,” “module,” and/or “engine,” as used herein Specification, can be inclusive of an executable file comprising instructions that can be understood and processed on a computer, and may further include library modules loaded during execution, object files, system files, hardware logic, software logic, or any other executable modules. Furthermore, the words “optimize,” “optimization,” and related terms are terms of art that refer to improvements in speed and/or efficiency of a specified outcome and do not purport to indicate that a process for achieving the specified outcome has achieved, or is capable of achieving, an “optimal” or perfectly speedy/perfectly efficient state.

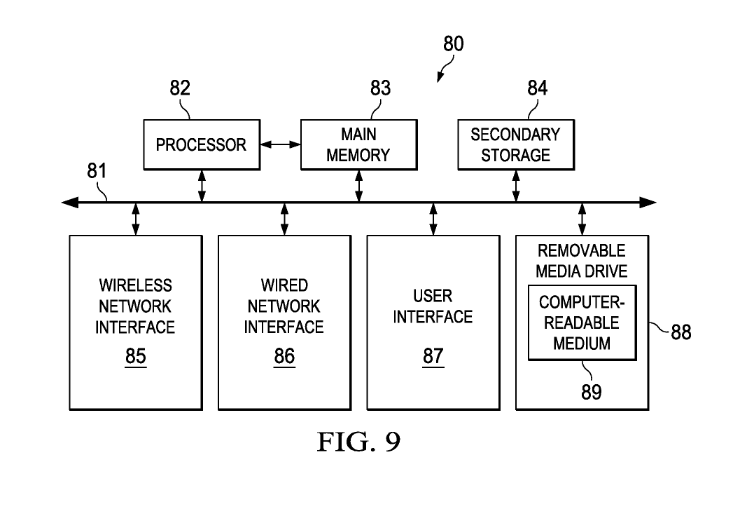

Turning to FIG. 9, FIG. 9 is a simplified block diagram of an example machine (or apparatus) 80, which in certain embodiments may comprise server 12, VIC 20, and/or router 28, in accordance with features of embodiments described herein. The example machine 80 corresponds to network elements and computing devices that may be deployed in system 10. In particular, FIG. 9 illustrates a block diagram representation of an example form of a machine within which software and hardware cause machine 80 to perform any one or more of the activities or operations discussed herein. As shown in FIG. 9, machine 80 may include a processor 82, a main memory 83, secondary storage 84, a wireless network interface 85, a wired network interface 86, a user interface 88, and a removable media drive 88 including a computer-readable medium 89. A bus 81, such as a system bus and a memory bus, may provide electronic communication between processor 82 and the memory, drives, interfaces, and other components of machine 80.

Processor 82, which may also be referred to as a central processing unit (“CPU”), can include any general or special-purpose processor capable of executing machine readable instructions and performing operations on data as instructed by the machine readable instructions. Main memory 83 may be directly accessible to processor 82 for accessing machine instructions and may be in the form of random access memory (“RAM”) or any type of dynamic storage (e.g., dynamic random access memory (“DRAM”)). Secondary storage 84 can be any non-volatile memory such as a hard disk, which is capable of storing electronic data including executable software files. Externally stored electronic data may be provided to computer 80 through one or more removable media drives 88, which may be configured to receive any type of external media such as compact discs (“CDs”), digital video discs (“DVDs”), flash drives, external hard drives, etc.

Wireless and wired network interfaces 85 and 86 can be provided to enable electronic communication between machine 80 and other machines via networks (e.g., network 26). In one example, wireless network interface 85 could include a wireless network controller (“WNIC”) with suitable transmitting and receiving components, such as transceivers, for wirelessly communicating within a network. Wired network interface 86 can enable machine 80 to physically connect to a network by a wire line such as an Ethernet cable. Both wireless and wired network interfaces 85 and 86 may be configured to facilitate communications using suitable communication protocols such as, for example, Internet Protocol Suite (“TCP/IP”). Machine 80 is shown with both wireless and wired network interfaces 85 and 86 for illustrative purposes only. While one or more wireless and hardwire interfaces may be provided in machine 80, or externally connected to machine 80, only one connection option is needed to enable connection of machine 80 to a network.

A user interface 87 may be provided in some machines to allow a user to interact with the machine 80. User interface 87 could include a display device such as a graphical display device (e.g., plasma display panel (“PDP”), a liquid crystal display (“LCD”), a cathode ray tube (“CRT”), etc.). In addition, any appropriate input mechanism may also be included such as a keyboard, a touch screen, a mouse, a trackball, voice recognition, touch pad, etc.

Removable media drive 88 represents a drive configured to receive any type of external computer-readable media (e.g., computer-readable medium 89). Instructions embodying the activities or functions described herein may be stored on one or more external computer-readable media. Additionally, such instructions may also, or alternatively, reside at least partially within a memory element (e.g., in main memory 83 or cache memory of processor 82) of machine 80 during execution, or within a non-volatile memory element (e.g., secondary storage 84) of machine 80. Accordingly, other memory elements of machine 80 also constitute computer-readable media. Thus, “computer-readable medium” is meant to include any medium that is capable of storing instructions for execution by machine 80 that cause the machine to perform any one or more of the activities disclosed herein.

Not shown in FIG. 9 is additional hardware that may be suitably coupled to processor 82 and other components in the form of memory management units (“MMU”), additional symmetric multiprocessing (“SMP”) elements, physical memory, peripheral component interconnect (“PCI”) bus and corresponding bridges, small computer system interface (“SCSI”)/integrated drive electronics (“IDE”) elements, etc. Machine 80 may include any additional suitable hardware, software, components, modules, interfaces, or objects that facilitate the operations thereof. This may be inclusive of appropriate algorithms and communication protocols that allow for the effective protection and communication of data. Furthermore, any suitable operating system may also be configured in machine 80 to appropriately manage the operation of the hardware components therein.

The elements, shown and/or described with reference to machine 80, are intended for illustrative purposes and are not meant to imply architectural limitations of machines such as those utilized in accordance with the present disclosure. In addition, each machine (e.g., server 12, VIC 20, and/or router 28) may include more or fewer components where appropriate and based on particular needs. As used herein in this Specification, the term “machine” is meant to encompass any computing device or network element such as servers, routers, personal computers, client computers, network appliances, switches, bridges, gateways, processors, load balancers, wireless LAN controllers, firewalls, or any other suitable device, component, element, or object operable to affect or process electronic information in a network environment.

In example implementations, at least some portions of the activities related to the system for enabling unconfigured devices to securely join an autonomic network, outlined herein may be implemented in software in, for example, server 12, VIC 20, and/or router 28. In some embodiments, this software could be received or downloaded from a web server, provided on computer-readable media, or configured by a manufacturer of a particular element in order to provide this system in accordance with features of embodiments described herein. In some embodiments, one or more of these features may be implemented in hardware, provided external to these elements, or consolidated in any appropriate manner to achieve the intended functionality.

In one example implementation, machine 80 is a network elements or computing device, which may include any suitable hardware, software, components, modules, or objects that facilitate the operations thereof, as well as suitable interfaces for receiving, transmitting, and/or otherwise communicating data or information in a network environment. This may be inclusive of appropriate algorithms and communication protocols that allow for the effective exchange of data or information.

Furthermore, in the embodiments of the system described and shown herein, some of the processors and memory elements associated with the various network elements may be removed, or otherwise consolidated such that a single processor and a single memory location are responsible for certain activities. Alternatively, certain processing functions could be separated and separate processors and/or physical machines could implement various functionalities. In a general sense, the arrangements depicted in the FIGURES may be more logical in their representations, whereas a physical architecture may include various permutations, combinations, and/or hybrids of these elements. It is imperative to note that countless possible design configurations can be used to achieve the operational objectives outlined here. Accordingly, the associated infrastructure has a myriad of substitute arrangements, design choices, device possibilities, hardware configurations, software implementations, equipment options, etc.

In some of the example embodiments, one or more memory elements (e.g., main memory 83, secondary storage 84, computer-readable medium 89) can store data used for the automatic configuration and registration operations described herein. This includes at least some of the memory elements being able to store instructions (e.g., software, logic, code, etc.) that are executed to carry out the activities described in this Specification. A processor can execute any type of instructions associated with the data to achieve the operations detailed herein in this Specification. In one example, one or more processors (e.g., processor 82) could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (“FPGA”), an erasable programmable read only memory (“EPROM”), an electrically erasable programmable read only memory (“EEPROM”)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

Components of system 10 may keep information in any suitable type of memory (e.g., random access memory (“RAM”), read-only memory (“ROM”), erasable programmable ROM (“EPROM”), electrically erasable programmable ROM (“EEPROM”), etc.), software, hardware, or in any other suitable component, device, element, or object where appropriate and based on particular needs. Any of the memory items discussed herein should be construed as being encompassed within the broad term “memory element.” The information being read, used, tracked, sent, transmitted, communicated, or received by system 10 could be provided in any database, register, queue, table, cache, control list, or other storage structure, all of which can be referenced at any suitable timeframe. Any such storage options may be included within the broad term “memory element” as used herein. Similarly, any of the potential processing elements and modules described in this Specification should be construed as being encompassed within the broad term “processor.”

Note that with the numerous examples provided herein, interaction may be described in terms of two, three, four, or more network elements. However, this has been done for purposes of clarity and example only. It should be appreciated that the system can be consolidated in any suitable manner. Along similar design alternatives, any of the illustrated computers, modules, components, and elements of the FIGURES may be combined in various possible configurations, all of which are clearly within the broad scope of this Specification. In certain cases, it may be easier to describe one or more of the functionalities of a given set of flows by only referencing a limited number of network elements. It should be appreciated that the system as shown in the FIGURES and its teachings are readily scalable and can accommodate a large number of components, as well as more complicated/sophisticated arrangements and configurations. Accordingly, the examples provided should not limit the scope or inhibit the broad teachings of the system as potentially applied to a myriad of other architectures.

It is also important to note that the operations and steps described with reference to the preceding FIGURES illustrate only some of the possible scenarios that may be executed by, or within, the system. Some of these operations may be deleted or removed where appropriate, or these steps may be modified or changed considerably without departing from the scope of the discussed concepts. In addition, the timing of these operations may be altered considerably and still achieve the results taught in this disclosure. The preceding operational flows have been offered for purposes of example and discussion. Substantial flexibility is provided by the system in that any suitable arrangements, chronologies, configurations, and timing mechanisms may be provided without departing from the teachings of the discussed concepts.

In the foregoing description, for purposes of explanation, numerous specific details are set forth in order to provide a thorough understanding of the disclosed embodiments. It will be apparent to one skilled in the art, however, that the disclosed embodiments may be practiced without these specific details. In other instances, structure and devices are shown in block diagram form in order to avoid obscuring the disclosed embodiments. In addition, references in the Specification to “one embodiment”, “example embodiment”, “an embodiment”, “another embodiment”, “some embodiments”, “various embodiments”, “other embodiments”, “alternative embodiment”, etc. are intended to mean that any features (e.g., elements, structures, modules, components, steps, operations, characteristics, etc.) associated with such embodiments are included in one or more embodiments of the present disclosure.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method comprising:
receiving at an interface controller associated with a host server and disposed between the host server and a network element a packet from a sender;
processing the packet to identify a rewrite rule to be applied to the packet based on characteristics of the packet;
applying the identified rewrite rule to the packet to generate a rewritten packet; and
forwarding the rewritten packet toward a next hop.

2. The method of claim 1, wherein the processing comprises classifying the packet, the classifying comprising identifying at least one of a type of traffic with which the packet is associated and an application with which the packet is associated.

3. The method of claim 1, wherein the processing comprises performing a flow table lookup for the packet to identify a flow with which the packet is associated.

4. The method of claim 1, wherein the processing comprises:
classifying the packet classifying the packet, the classifying comprising identifying at least one of a type of traffic with which the packet is associated and an application with which the packet is associated; and
performing a flow table lookup for the packet to identify a flow with which the packet is associated.

5. The method of claim 1, wherein the applying the rewrite rule comprises at least one of deleting byes of the packet, inserting bytes into packet, skipping byes of the packet, manipulating program registers using basic Arithmetic Logic Unit (“ALU”) operations, and performing a direct memory access of at least one of a memory device of the host server and a memory device of interface controller.

6. The method of claim 1, wherein the network element is a switch.

7. The method of claim 1, wherein the packet is received from a virtual machine (“VM”) hosted by the host server.

8. The method of claim 1, wherein the packet is received from the network element.

9. Non-transitory tangible media that includes code for execution and when executed by a processor is operable to perform operations comprising:
receiving at an interface controller associated with a host server and disposed between the host server and a network element a packet from a sender;
processing the packet to identify a rewrite rule to be applied to the packet based on characteristics of the packet;
applying the identified rewrite rule to the packet to generate a rewritten packet; and
forwarding the rewritten packet toward a next hop.

10. The media of claim 9, wherein the processing comprises classifying the packet, the classifying comprising identifying at least one of a type of traffic with which the packet is associated and an application with which the packet is associated.

11. The media of claim 9, wherein the processing comprises performing a flow table lookup for the packet to identify a flow with which the packet is associated.

12. The media of claim 9, wherein the processing comprises:
classifying the packet classifying the packet, the classifying comprising identifying at least one of a type of traffic with which the packet is associated and an application with which the packet is associated; and
performing a flow table lookup for the packet to identify a flow with which the packet is associated.

13. The media of claim 9, wherein the applying the rewrite rule comprises at least one of deleting byes of the packet, inserting bytes into packet, skipping byes of the packet, manipulating program registers using basic Arithmetic Logic Unit (“ALU”) operations, and performing a direct memory access of at least one of a memory device of the host server and a memory device of interface controller.

14. The media of claim 9, wherein the network element is a switch.

15. An apparatus comprising:
a memory element configured to store data; and
a processor operable to execute instructions associated with the data;
wherein the apparatus is configured to:
receive at an interface controller associated with a host server and disposed between the host server and a network element a packet from a sender;
process the packet to identify a rewrite rule to be applied to the packet based on characteristics of the packet;
apply the identified rewrite rule to the packet to generate a rewritten packet; and
forward the rewritten packet toward a next hop.

16. The apparatus of claim 15, wherein the processing comprises classifying the packet, the classifying comprising identifying at least one of a type of traffic with which the packet is associated and an application with which the packet is associated.

17. The apparatus of claim 15, wherein the processing comprises performing a flow table lookup for the packet to identify a flow with which the packet is associated.

18. The apparatus of claim 15, wherein the processing comprises:
classifying the packet classifying the packet, the classifying comprising identifying at least one of a type of traffic with which the packet is associated and an application with which the packet is associated; and
performing a flow table lookup for the packet to identify a flow with which the packet is associated.

19. The apparatus of claim 15, wherein the applying the rewrite rule comprises at least one of deleting byes of the packet, inserting bytes into packet, skipping byes of the packet, manipulating program registers using basic Arithmetic Logic Unit (“ALU”) operations, and performing a direct memory access of at least one of a memory device of the host server and a memory device of interface controller.

20. The apparatus of claim 15, wherein the network element is a switch.
